(19) United States
(12) Patent Application Publication
(10) Pub. No.: US 2017/0177543 A1
(43) Pub. Date: Jun. 22, 2017

(54) AGGREGATE SCATTER INSTRUCTIONS

(71) Applicant: Intel Corporation, Santa Clara, CA (US)

(72) Inventors: Ashish Jha, Portland, OR (US); Elmoustapha Ould-Ahmed-Vall, Chandler, AZ (US); Robert Valentine, Kiryat Tivon (IL); Mark J. Charney, Lexington, MA (US); Milind B. Girkar, Sunnyvale, CA (US)

(21) Appl. No.: 14/979,047

(22) Filed: Dec. 22, 2015

(51) Int. Cl. G06F 15/80; G06F 9/30

(52) U.S. Cl. CPC G06F 15/8007; G06F 9/30098; G06F 9/3016

(57) ABSTRACT

An Aggregate Scatter instruction is described. A processor may include a memory interface and a register to store data elements of a data structure. The data elements may be contiguously stored in a first location in a memory accessible via the memory interface. The processor may further include a decoder to decode an aggregate scatter instruction specifying a store operation for the data structure and an execution unit to contiguously store the data elements to a second storage location in the memory in response to the decoded aggregate scatter instruction. The second storage location may be identified by a starting memory address of the second storage location.

The present disclosure pertains to the field of processors and, in particular, to aggregate scatter instructions in a processor.

### BACKGROUND

To improve the efficiency of multimedia applications, as well as other applications with similar characteristics, Single Instruction, Multiple Data (SIMD) architectures in microprocessor systems enable one instruction to operate on several operands in parallel. In particular, SIMD architectures take advantage of packing many data elements within one register or contiguous memory location. With parallel hardware execution, multiple operations are performed on separate data elements by one instruction.

### BRIEF DESCRIPTION OF THE DRAWINGS

Various embodiments of the present disclosure will be understood more fully from the detailed description given below and from the accompanying drawings of various embodiments of the disclosure. The drawings, however, should not be taken to limit the disclosure to the specific implementations, but are for explanation and understanding only.

FIG. 1 is a block diagram illustrating a computing system that implements an Aggregate Scatter instruction according to one embodiment.

FIG. 2 illustrates a diagram of a method of performing an Aggregate Scatter instruction according to one embodiment.

FIG. 3A illustrates an example Single Instruction, Multiple Data (SIMD) Aggregate Scatter instruction according to one embodiment.

FIG. 3B further illustrates an example Single Instruction, Multiple Data (SIMD) Aggregate Scatter instruction according to one embodiment.

FIG. 4A is a block diagram illustrating a micro-architecture for a processor that implements Aggregate Scatter operations according to one embodiment.

FIG. 4B is a block diagram illustrating an in-order pipeline and a register renaming stage, out-of-order issue/execution pipeline according to one embodiment.

FIG. 5 illustrates a block diagram of the micro-architecture for a processor that includes logic circuits to perform Aggregate Scatter operations according to one embodiment.

FIG. 6 is a block diagram of a computer system according to one embodiment.

FIG. 7 is a block diagram of a computer system according to another embodiment.

FIG. 8 is a block diagram of a system-on-a-chip according to one embodiment.

FIG. 9 illustrates another implementation of a block diagram for a computing system according to one embodiment.

FIG. 10 illustrates another implementation of a block diagram for a computing system according to one implementation.

### DESCRIPTION OF EMBODIMENTS

Processors may use single instruction, multiple data (SIMD) instruction sets to perform multiple operations in parallel. A processor can perform multiple operations in parallel, simultaneously applying operations to the same piece of data or multiple pieces of data at the same time. SIMD performance improvements may be difficult to attain in applications involving irregular memory access patterns. For example, applications storing data tables that require frequent and random updates to data elements, which may or may not be stored in contiguous memory locations, typically require rearrangement of the data in order to fully utilize SIMD hardware. This rearrangement of data can result in substantial overhead, thus limiting the efficiencies attained from SIMD hardware.

As SIMD vector widths increase (i.e., the number of data elements upon which the single operation is performed), application developers (and compilers) are finding it increasingly difficult to fully utilize SIMD hardware due to the overhead associated with rearranging data elements stored in noncontiguous memory storage. Thus, there is a need to more efficiently handle noncontiguous memory access patterns in SIMD architectures.

SIMD instruction sets may include an instruction to perform a scatter operation, as well as a gather instruction. A gather instruction is an instruction that reads a set of data elements from memory and packs them together, possibly into a single register or cache line. The usefulness of a gather instruction is especially noticeable when the data elements to be read are spread out (noncontiguous) in memory. A gather instruction reads each data element of a set (e.g., a struct) from its noncontiguous location in memory and stores it contiguously with other data elements of the set for future accessibility.

A struct is a data type declaration that defines a physically grouped list of data elements to be stored under one name in a block of memory. Such an arrangement allows for each data element in the struct to be accessed by a single pointer (memory address). In one embodiment, the packed data structure is an array of structures (array of structs). Similar data elements within an array of data structures may be stored contiguously in registers (e.g., vector registers) by a gather instruction. For example, for an array of two data structures that each contain data elements x, y, and z, the two x's might be stored together in a register, the two y's might be stored in a register together, and the two z's might be stored in a register together.

A scatter instruction performs the reverse operation as a gather instruction by writing out a set of data elements contiguously stored in one or more registers or cache lines to noncontiguous memory locations. It is worth mentioning that computations may have been applied to the data elements after the gather and before the scatter instructions. The scatter operation writes data elements in a packed data structure (e.g., struct) to set of noncontiguous or random memory locations. A conventional scatter instruction to store the six data elements of the two arrays of structs back to memory may inefficiently perform six store operations to memory, one store operation for each data element.

The embodiments described herein may address the above noted inefficiency by providing an Aggregate Scatter instruction that stores entire data structures of data elements in registers, instead of storing individual data elements with other similar data elements. By storing entire data structures in registers instead of grouped, similar data elements themselves, an Aggregate Scatter instruction reduces the number of store operations performed by a conventional scatter instruction. Take, for example, the above hypothetical with an array of two structs, each containing a data element x, y, and z. Performing an Aggregate Scatter instruction on the array results in only two store operations back to memory since a single register contains two pointers, one for each array of structs, and the structs may therefore be written to memory without concern for individual stores of data elements. Instead of storing each data element back to memory according to kind, whole structs (each containing various data elements) are stored back to memory in a single store operation. Thus, in the above example where each packed data structure contains three data elements, Aggregate Scatter reduces the number of required store operations back to memory by three times, two stores compared to six. A struct may contain any number of data elements and the efficiency gained by an Aggregate Scatter instruction increases according to the number of data elements contained in each data structure.

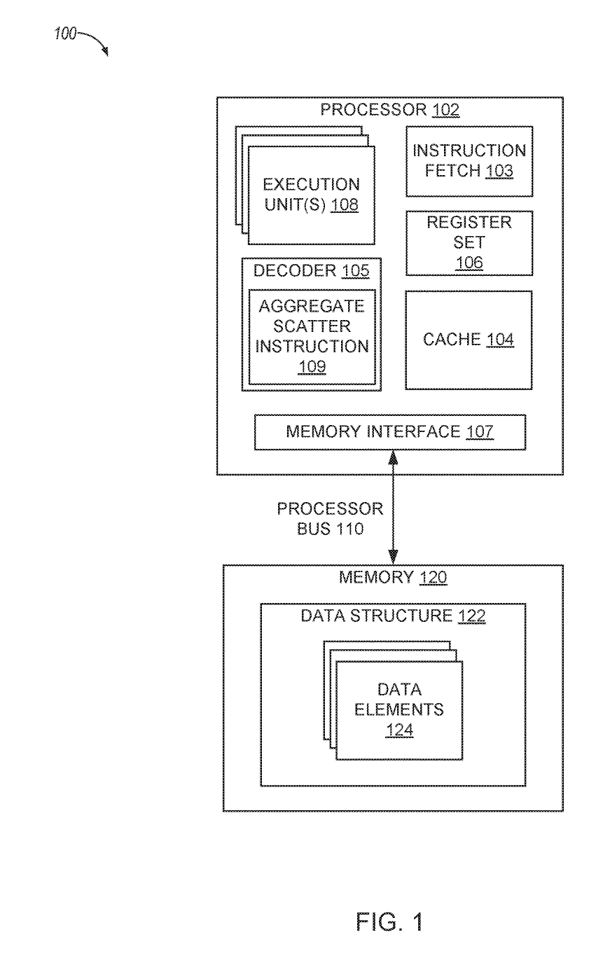

FIG. 1 is a block diagram illustrating a computing system 100 that implements an Aggregate Scatter instruction according to one embodiment. The computing system 100 is formed with a processor 102 that includes one or more execution units 108 to execute an Aggregate Scatter instruction 109 and a memory decoder 105 to decode Aggregate Scatter instruction 109, which implements one or more features in accordance with one or more embodiments as described herein. The computing system 100 may be any device, but the description of various embodiments described herein is directed to SIMD processors.

In a further embodiment, the processor 102 includes an instruction fetch unit 103 to fetch instructions (e.g., Aggregate Scatter instruction 109) for one or more applications executed by the processor 102. In another embodiment, the instruction fetch unit 103 fetches Aggregate Scatter instruction 109. Decoder 105 may then decode Aggregate Scatter instruction 109.

A register (e.g., register set 106) may store data elements 124 of a first data structure 122, where the data elements are originally contiguously stored in a first location in memory 120 accessible via the memory interface 107. Register set 106 is to store different types of data in various registers including integer registers, floating point registers, vector registers, banked registers, shadow registers, checkpoint registers, status registers, and instruction pointer register. Vector registers may hold data for vector processing by SIMD instructions (e.g., Aggregate Scatter instruction).

Decoder 105 may then decode Aggregate Scatter instruction 109, which specifies a store operation for the first data structure 122. The execution unit 108 may then, in response to the decoded Aggregate Scatter instruction 109, contiguously store the first set of data elements 124 of the first data structure 122 to a second storage location in the memory 120, the second storage location identified by a starting memory address of the second storage. Because data elements of a data structure are stored contiguously, execution unit 108 writes out the entire data structure to a contiguous block of memory, without concern for where individual data elements are located within the data structure.

Execution unit 108, including logic to perform integer and floating point operations, as well as vector operations, also resides in the processor 102. It should be noted that the execution unit may or may not have a floating point unit. The processor 102, in one embodiment, includes a microcode (ucode) ROM to store microcode, which when executed, is to perform algorithms for certain macroinstructions or handle complex scenarios. Here, microcode is potentially updateable to handle logic bugs/fixes for processor 102.

Alternate embodiments of an execution unit 108 may also be used in micro controllers, embedded processors, graphics devices, DSPs, and other types of logic circuits. System 100 includes a memory interface 107 and memory 120. In one embodiment, memory interface 107 may be a bus protocol for communication from processor 102 to memory 120. Memory 120 includes a dynamic random access memory (DRAM) device, a static random access memory (SRAM) device, flash memory device, or other memory device. Memory 120 stores instructions and/or data represented by data signals that are to be executed by the processor 102. The processor 102 is coupled to the memory 120 via a processor bus 110. A system logic chip, such as a memory controller hub (MCH) may be coupled to the processor bus 110 and memory 120. An MCH can provide a high bandwidth memory path to memory 120 for instruction and data storage and for storage of graphics commands, data and textures. The MCH can be used to direct data signals between the processor 102, memory 120, and other components in the system 100 and to bridge the data signals between processor bus 110, memory 120, and system I/O, for example. The MCH may be coupled to memory 120 through a memory interface (e.g., memory interface 107). In some embodiments, the system logic chip can provide a graphics port for coupling to a graphics controller through an Accelerated Graphics Port (AGP) interconnect. The system 100 may also include an I/O controller hub (ICH). The ICH can provide direct connections to some I/O devices via a local I/O bus. The local I/O bus is a high-speed I/O bus for connecting peripherals to the memory 120, chipset, and processor 102. Some examples are the audio controller, firmware hub (flash BIOS), wireless transceiver, data storage, legacy I/O controller containing user input and keyboard interfaces, a serial expansion port such as Universal Serial Bus (USB), and a network controller. The data storage device can include a hard disk drive, a floppy disk drive, a CD-ROM device, a flash memory device, or other mass storage device. Various operations are performed to carry out the Aggregate Scatter instruction, as described herein.

Processor 102 may employ execution units 108, including logic to perform algorithms for processing data and performing operations related to Aggregate Scatter instruction 109, in accordance with the embodiment described herein. System 100 is representative of processing systems based on the PENTIUM III™, PENTIUM 4™, Xeon™, Itanium, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 100 executes a version of the WINDOWS™ operating system available from Microsoft Corporation of Redmond, Wash., although other operating systems (UNIX and Linux for example), embedded software, and/or graphical user interfaces, may also be used. Thus, embodiments of the present disclosure are not limited to any specific combination of hardware circuitry and software.

Embodiments are not limited to computer systems. Alternative embodiments of the present disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 102 includes one or more execution units 108 to implement an algorithm that is to perform at least one Aggregate Scatter instruction 109. One embodiment may be described in the context of a single processor desktop or server system, but alternative embodiments may be included in a multiprocessor system. System 100 may be an example of a ‘hub’ system architecture. The computer system 100 includes a processor 102 to process data signals. The processor 102, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102 is coupled to a processor bus 110 that transmits data signals between the processor 102 and other components in the system 100. Other elements of system 100 may include a graphics accelerator, memory controller hub, I/O controller hub, wireless transceiver, Flash BIOS, Network controller, Audio controller, Serial expansion port, I/O controller, etc.

In one embodiment, the processor 102 includes a Level 1 (L1) internal cache memory 104. Depending on the architecture, the processor 102 may have a single internal cache or multiple levels of internal caches. Other embodiments include a combination of both internal and external caches depending on the particular implementation and needs.

For another embodiment of a system, Aggregate Scatter instruction 109 can be implemented by a system on a chip (SoC). One embodiment of a SoC includes of a processor and a memory. The memory the SoC may be is a flash memory. The flash memory can be located on the same die as the processor and other system components. Additionally, other logic blocks such as a memory controller or graphics controller can also be located on a SoC.

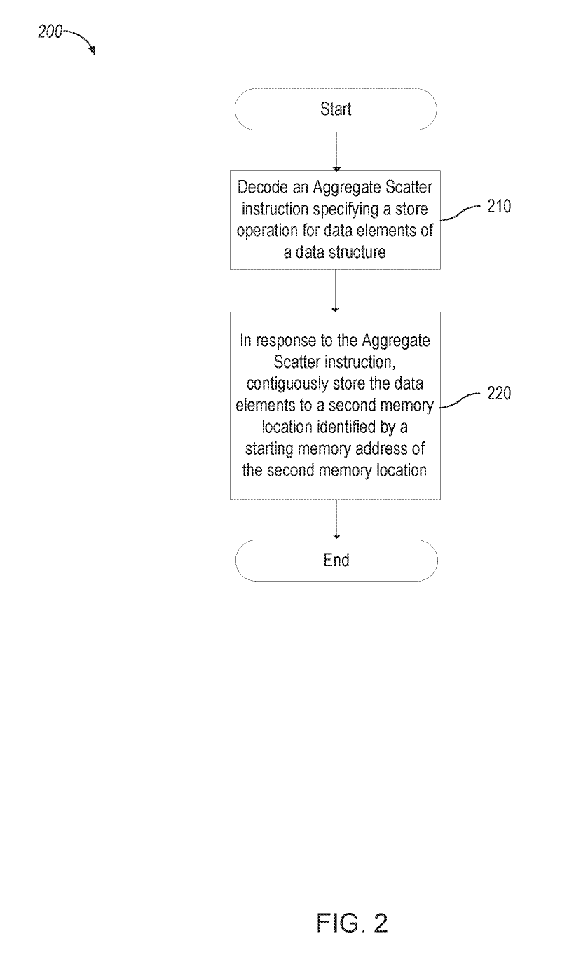

FIG. 2 illustrates a diagram of a method of performing an Aggregate Scatter instruction according to one embodiment. The method 200 may be performed by processing logic that includes hardware (e.g., circuitry, dedicated logic, programmable logic, microcode, etc.), software (e.g., instructions run on a processing device to perform hardware simulation), or a combination thereof. In one embodiment, components of system 100 executing on the processor 102 perform method 200.

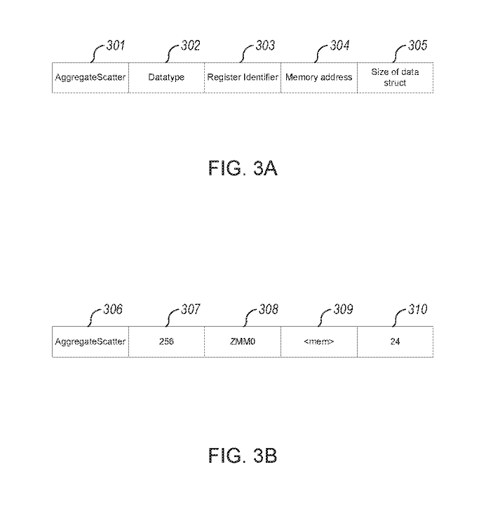

Referring to FIG. 2, at block 210, possessing logic decodes an Aggregate Scatter instruction specifying a store operation for a set of data elements of a data structure. More detail regarding the decoding of the Aggregate Scatter instruction itself is provided with respect to FIGS. 3A and 3B. In one embodiment, decoder 105 of FIG. 1 may decode the Aggregate Scatter instruction.

In one embodiment, the data elements may have originally been contiguously stored in a first location in a memory accessible via a memory interface. Processing logic may then have stored the data structure (e.g., the individual data elements 124 of the data structure) in a register (e.g., register set 106) associated with the processor 102. The processor may read data elements from memory, staging them in registers for the execution unit to perform computations on the data elements. In one embodiment, the data elements are data elements of a defined structure (struct). Multiple structs may be associated with each other in an array of structs.

In one embodiment, data elements of a struct may originally be stored contiguously in memory in a memory block allocated to the struct, where each data element is located within a fixed offset from the starting address (e.g. the pointer, the base address, etc.) of the memory block. Take, for example, a struct “Atom” that contains three data elements x, y, and z, where each data element is 256 bits in size. Such a struct may be created in C with the following:

```
Struct Atom {
      Double x;
      Double y;
      Double z;
      }
```

If the starting address of the struct is x0000, the first data element of the struct, x in this case, is located at x0000. The size of the data elements is 256 bits, and therefore the stride value is also 256. Thus, data element y may be located by adding the stride value (256) to the starting address of the struct (x0000) to yield x0100. Likewise, data element z may be found by adding two strides values to the starting address, thus yielding the memory address x0200.

In one embodiment, more than one data structure may be stored in a single register. Although embodiments of the present disclosure frequently refer to a single register that stores two data structures, it is worth noting that any number of data structures may be stored in the register. In one embodiment, a register ZMMO may have two sets of bits (e.g., lanes). For example, a 512 bit register may include a 256 bit “low” lane to store a first data structure and a 256 bit “high” lane to store a second data structure. For example, for atomArray( ) which may be an array of Atom structs each of a 256 bit datatype, 512 bit register ZMMO may store the first Atom struct (designated as atomArray(0)) in lo256 b, and the second Atom struct (designated as atomArray(1)) in hi256 b. The stride value between contiguous structs, in this case, is 256 b. Storing a contiguous set of data elements of a struct into registers allows for all data elements of a struct to be stored to memory in a single operation, instead of storing each element of the struct individually. Because the data elements are stored contiguously within the struct the Aggregate Scatter instruction can store the entire struct to a contiguous block of memory, instead of performing individual store operations on each of the data elements as done conventionally.

In response to the decoded aggregate scatter instruction, at block 220, processing logic may store the set of data elements of the first data structure to a second storage location in contiguous locations in memory. In one embodiment, execution unit 108 of FIG. 1 performs this operation. The second storage location may be identified by a starting address of the second memory location.

In one embodiment, the starting address of the second memory location is provided by the Aggregate Scatter instruction as described with respect to FIGS. 3A and 3B, below. In one embodiment, the first storage location and the second storage location are the same location in memory. In another embodiment, the first storage location and the second storage location are different locations in memory.

FIGS. 3A and 3B illustrate an example Single Instruction, Multiple Data (SIMD) Aggregate Scatter instruction according to one embodiment.

As shown, an Aggregate Scatter instruction may include fields that specify additionally details about the data to be processed. A compiler may translate an Aggregate Scatter instruction, such as the instruction of FIGS. 3A and 3B, into a machine language instruction.

In fields 301 and 306 of the Aggregate Scatter instruction, an Aggregate Scatter instruction identifier is provided. A compiler may translate the Aggregate Scatter identifier into an appropriate machine language opcode that identifies the Aggregate Scatter operation to be performed. In field 302, the datatype of the structure that is to be stored is provided. A datatype of the structure may be, for example, Byte (e.g., 8b), Word (e.g., 32 b or 64 b), Double Word (e.g., 64 b or 128), or Quad Word (e.g., 128 b or 256 b). In field 307, the provided datatype is 256 (bits). The datatype may be referred to as a stride value, where the stride value defines the distance between multiple data structures stored in the same register. For example, a second data structure may be stored in a second lane of register ZMMO. For Aggregate Store operations to store the first and second data structures to memory, the starting address of the first data structure is identified in the register by the starting address of ZMMO, since the first data structure is located in the first position in the register (e.g., the low 256 b lane of the register). In one embodiment, the register is a vector register. The starting address of the second data structure (which may be in the high 256 b lane of the register) may be located by adding 256 b (the provided datatype of the first data structure) to the base address of the register ZMMO. In one embodiment, the first and second data structures are stored to noncontiguous memory locations. In another embodiment, the first and second data structures are stored to contiguous memory locations.

Fields 303 and 308 identify the particular register in which the data structure to be stored to a memory location is currently stored. Fields 303 and 308, referred to as operands, specify the data that an instruction will process. Register ZMMO is identified by operand 308 as the register that contains the data structure to be stored. Fields 304 and 309 contain the starting memory address of the location to which the data structure is to be stored. The starting memory address of the memory location may be referred to as a base address and/or a pointer.

Finally, field 305 identifies the size of the data structure to be stored. An Aggregate Scatter operation may store a subset of the first data structure, the subset being the data elements occupying a space up to the size of the data structure. The subset to be stored may be less than the size of the datatype. For example, consider the example instruction AggregateScatter256 ZMMO, <mem>, 24. The datatype of the data structure is identified as 256, which means that the data structure is contained in a 256 b lane of the register. The size of the structure, however, is identified as 24 Bytes. 24 Bytes is only 192 bits (24*8) so the data structure does not occupy the entire 256 b lane of the register. Therefore, only the first 192 b of the 256 b lane will be written from register ZMMO to the memory location identified by the instruction (e.g., the starting address “<mem>”).

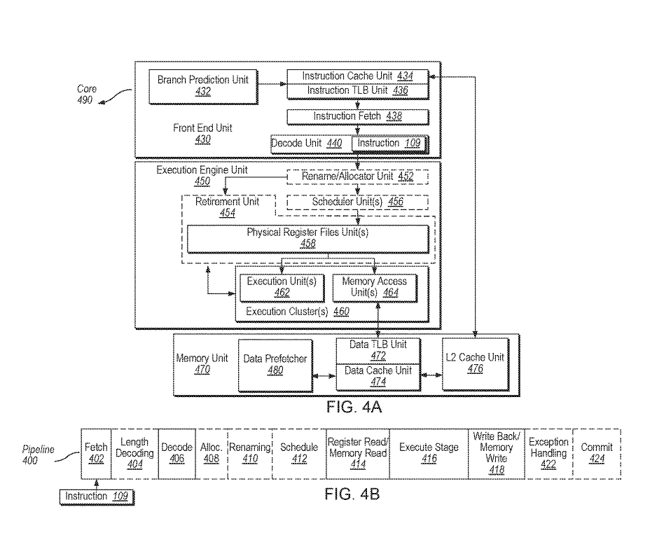

FIG. 4A is a block diagram illustrating a micro-architecture for a processor 400 that implements Aggregate Scatter operations, according to one embodiment. Specifically, processor 400 depicts an in-order architecture core and a register renaming logic, out-of-order issue/execution logic to be included in a processor according to at least one embodiment of the disclosure. The embodiments of the Aggregate Scatter operations described herein can be implemented in processor 400.

Processor 400 includes a front end unit 430 coupled to an execution engine unit 450, and both are coupled to a memory unit 470. The processor 400 may include a reduced instruction set computing (RISC) core, a complex instruction set computing (CISC) core, a very long instruction word (VLIW) core, or a hybrid or alternative core type. As yet another option, processor 400 may include a special-purpose core, such as, for example, a network or communication core, compression engine, graphics core, or the like. In one embodiment, processor 400 may be a multi-core processor or may be part of a multi-processor system.

The front end unit 430 includes a branch prediction unit 432 coupled to an instruction cache unit 434, which is coupled to an instruction translation lookaside buffer (TLB) 436, which is coupled to an instruction fetch unit 438, which is coupled to a decode unit 440. The decode unit 440 (also known as a decoder) may decode instructions (e.g., Aggregate Scatter instruction 109), and generate as an output one or more micro-operations, micro-code entry points, microinstructions, other instructions, or other control signals, which are decoded from, or which otherwise reflect, or are derived from, the original instructions. The decoder 440 may be implemented using various different mechanisms. Examples of suitable mechanisms include, but are not limited to, look-up tables, hardware implementations, programmable logic arrays (PLAs), microcode read only memories (ROMs), etc. The instruction cache unit 434 is further coupled to the memory unit 470. The decode unit 440 is coupled to a rename/allocator unit 452 in the execution engine unit 450.

The execution engine unit 450 includes the rename/allocator unit 452 coupled to a retirement unit 454 and a set of one or more scheduler unit(s) 456. The scheduler unit(s) 456 represents any number of different schedulers, including reservations stations (RS), central instruction window, etc. The scheduler unit(s) 456 is coupled to the physical register file(s) unit(s) 458. Each of the physical register file(s) units 458 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 458 is overlapped by the retirement unit 454 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.).

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 454 and the physical register file(s) unit(s) 458 are coupled to the execution cluster(s) 460. The execution cluster(s) 460 includes a set of one or more execution units 462 and a set of one or more memory access units 464. The execution units 462 may perform various operations (e.g., shifts, addition, subtraction, multiplication) and operate on various types of data (e.g., scalar floating point, packed integer, packed floating point, vector integer, vector floating point).

While some embodiments may include a number of execution units dedicated to specific functions or sets of functions, other embodiments may include only one execution unit or multiple execution units that all perform all functions. The scheduler unit(s) 456, physical register file(s) unit(s) 458, and execution cluster(s) 460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 464). It should also be understood that where separate pipelines are used, one or more of these pipelines may be out-of-order issue/execution and the rest in-order.

The set of memory access units 464 is coupled to the memory unit 470, which may include a data prefetcher 480, a data TLB unit 472, a data cache unit (DCU) 474, and a level 2 (L2) cache unit 476, to name a few examples. In some embodiments DCU 474 is also known as a first level data cache (L1 cache). The DCU 474 may handle multiple outstanding cache misses and continue to service incoming stores and loads. It also supports maintaining cache coherency. The data TLB unit 472 is a cache used to improve virtual address translation speed by mapping virtual and physical address spaces. In one exemplary embodiment, the memory access units 464 may include a load unit, a store address unit, and a store data unit, each of which is coupled to the data TLB unit 472 in the memory unit 470. The L2 cache unit 476 may be coupled to one or more other levels of cache and eventually to a main memory.

In one embodiment, the data prefetcher 480 speculatively loads/prefetches data to the DCU 474 by automatically predicting which data a program is about to consume. Prefetching may refer to transferring data stored in one memory location (e.g., position) of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

The processor 400 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes a separate instruction and data cache units and a shared L2 cache unit, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

FIG. 4B is a block diagram illustrating an in-order pipeline and a register renaming stage, out-of-order issue/execution pipeline implemented by processor 400 of FIG. 4A according to some embodiments of the disclosure. The solid lined boxes in FIG. 4B illustrate an in-order pipeline, while the solid lined boxes in combination with the dashed lined boxes illustrate a register renaming, out-of-order issue/execution pipeline. In FIG. 4B, a processor pipeline 400 includes a fetch stage 402 (to fetch Aggregate Scatter instruction 109, for example), a length decode stage 404, a decode stage 406, an allocation stage 408, a renaming stage 410, a scheduling (also known as a dispatch or issue) stage 412, a register read/memory read stage 214, an execute stage 416, a write back/memory write stage 418, an exception handling stage 422, and a commit stage 424. In some embodiments, the ordering of stages 402-424 may be different than illustrated and are not limited to the specific ordering shown in FIG. 4B.

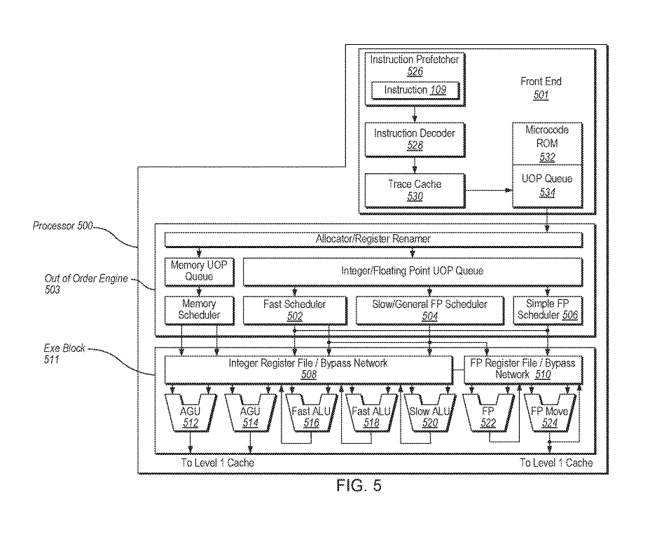

FIG. 5 illustrates a block diagram of the micro-architecture for a processor 500 that includes logic circuits to perform Aggregate Scatter operations, according to one embodiment. In some embodiments, an Aggregate Scatter instruction in accordance with one embodiment can be implemented to operate on data elements having sizes of byte, word, doubleword, quadword, etc., as well as datatypes, such as single and double precision integer and floating point datatypes. In one embodiment the in-order front end 501 is the part of the processor 500 that fetches instructions to be executed and prepares them to be used later in the processor pipeline. The embodiments of the Aggregate Scatter operations disclosed herein can be implemented in processor 500.

The front end 501 may include several units. In one embodiment, the instruction prefetcher 526 fetches instructions (e.g., Aggregate Scatter instruction 109) from memory and feeds them to an instruction decoder 528 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 530 takes decoded uops and assembles them into program ordered sequences or traces in the uop queue 534 for execution. When the trace cache 530 encounters a complex instruction, the microcode ROM 532 provides the uops needed to complete the operation.

Some instructions are converted into a single micro-op, whereas others need several micro-ops to complete the full operation. In one embodiment, if more than four micro-ops are needed to complete an instruction, the decoder 518 accesses the microcode ROM 532 to do the instruction. For one embodiment, an instruction can be decoded into a small number of micro ops for processing at the instruction decoder 518. In another embodiment, an instruction can be stored within the microcode ROM 532 should a number of micro-ops be needed to accomplish the operation. The trace cache 530 refers to an entry point programmable logic array (PLA) to determine a correct micro-instruction pointer for reading the micro-code sequences to complete one or more instructions in accordance with one embodiment from the micro-code ROM 532. After the microcode ROM 532 finishes sequencing micro-ops for an instruction, the front end 501 of the machine resumes fetching micro-ops from the trace cache 530.

The out-of-order execution engine 503 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 502, slow/general floating point scheduler 504, and simple floating point scheduler 506. The uop schedulers 502, 504, 506, determine when a uop is ready to execute based on the readiness of their dependent input register operand sources and the availability of the execution resources the uops need to complete their operation. The fast scheduler 502 of one embodiment can schedule on each half of the main clock cycle while the other schedulers can only schedule once per main processor clock cycle. The schedulers arbitrate for the dispatch ports to schedule uops for execution.

Register files 508, 510, sit between the schedulers 502, 504, 506, and the execution units 512, 514, 516, 518, 520, 522, 524 in the execution block 511. There is a separate register file 508, 510, for integer and floating point operations, respectively. Each register file 508, 510, of one embodiment also includes a bypass network that can bypass or forward just completed results that have not yet been written into the register file to new dependent uops. The integer register file 508 and the floating point register file 510 are also capable of communicating data with the other. For one embodiment, the integer register file 508 is split into two separate register files, one register file for the low order 32 bits of data and a second register file for the high order 32 bits of data. The floating point register file 510 of one embodiment has 128 bit wide entries because floating point instructions typically have operands from 64 to 128 bits in width.

The execution block 511 contains the execution units 512, 514, 516, 518, 520, 522, 524, where the instructions are actually executed. This section includes the register files 508, 510, that store the integer and floating point data operand values that the micro-instructions need to execute. The processor 500 of one embodiment includes a number of execution units: address generation unit (AGU) 512, AGU 514, fast ALU 516, fast ALU 518, slow ALU 520, floating point ALU 522, floating point move unit 524. For one embodiment, the floating point execution blocks 512, 514, execute floating point, MMX, SIMD, and SSE, or other operations. The floating point ALU 512 of one embodiment includes a 64 bit by 64 bit floating point divider to execute divide, square root, and remainder micro-ops. For embodiments of the present disclosure, instructions involving a floating point value may be handled with the floating point hardware.

In one embodiment, the ALU operations go to the high-speed ALU execution units 516, 518. The fast ALUs 516, 518, of one embodiment can execute fast operations with an effective latency of half a clock cycle. For one embodiment, most complex integer operations go to the slow ALU 510 as the slow ALU 510 includes integer execution hardware for long latency type of operations, such as a multiplier, shifts, flag logic, and branch processing. Memory load/store operations are executed by the AGUs 512, 514. For one embodiment, the integer ALUs 516, 518, 520, are described in the context of performing integer operations on 64 bit data operands. In alternative embodiments, the ALUs 516, 518, 520, can be implemented to support a variety of data bits including 16, 32, 128, 256, etc. Similarly, the floating point units 512, 514, can be implemented to support a range of operands having bits of various widths. For one embodiment, the floating point units 512, 514, can operate on 128 bits wide packed data operands in conjunction with SIMD and multimedia instructions (e.g., Aggregate Scatter instruction 109).

In one embodiment, the uops schedulers 502, 504, 506, dispatch dependent operations before the parent load has finished executing. As uops are speculatively scheduled and executed in processor 500, the processor 500 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The processor 500 also includes logic to implement Aggregate Scatter operations according to one embodiment. In one embodiment, the execution block 511 of processor 500 may include a microcontroller (MCU), to perform Aggregate Scatter operations according to the description herein.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data.

For the discussions herein, the registers are understood to be data registers designed to hold packed data, such as 64 bits wide MMXTM registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

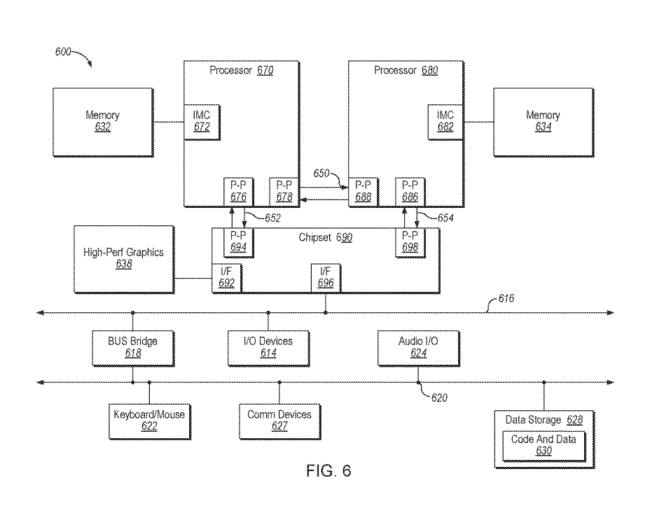

Embodiments may be implemented in many different system types. Referring now to FIG. 6, shown is a block diagram of a multiprocessor system 600 in accordance with an implementation. As shown in FIG. 6, multiprocessor system 600 is a point-to-point interconnect system, and includes a first processor 670 and a second processor 680 coupled via a point-to-point interconnect 650. As shown in FIG. 6, each of processors 670 and 680 may be multicore processors, including first and second processor cores (i.e., processor cores 574a and 574b and processor cores 584a and 584b), although potentially many more cores may be present in the processors. The processors each may include hybrid write mode logics in accordance with an embodiment of the present. Aggregate Scatter operations discussed herein can be implemented in the processor 670, processor 680, or both.

While shown with two processors 670, 680, it is to be understood that the scope of the present disclosure is not so limited. In other implementations, one or more additional processors may be present in a given processor.

Processors 670 and 680 are shown including integrated memory controller units 672 and 682, respectively. Processor 670 also includes as part of its bus controller units point-to-point (P-P) interfaces 676 and 688; similarly, second processor 680 includes P-P interfaces 686 and 688. Processors 670, 680 may exchange information via a point-to-point (P-P) interface 650 using P-P interface circuits 678, 688. As shown in FIG. 6, IMCs 672 and 682 couple the processors to respective memories, namely a memory 632 and a memory 634, which may be portions of main memory locally attached to the respective processors.

Processors 670, 680 may each exchange information with a chipset 690 via individual P-P interfaces 652, 654 using point to point interface circuits 676, 694, 686, 698. Chipset 690 may also exchange information with a high-performance graphics circuit 638 via a high-performance graphics interface 639.

A shared cache (not shown) may be included in either processor or outside of both processors, yet connected with the processors via P-P interconnect, such that either or both processors' local cache information may be stored in the shared cache if a processor is placed into a low power mode.

Chipset 690 may be coupled to a first bus 616 via an interface 692. In one embodiment, first bus 616 may be a Peripheral Component Interconnect (PCI) bus, or a bus such as a PCI Express bus or another third generation I/O interconnect bus, although the scope of the present disclosure is not so limited.

As shown in FIG. 6, various I/O devices 614 may be coupled to first bus 616, along with a bus bridge 618 which couples first bus 616 to a second bus 620. In one embodiment, second bus 620 may be a low pin count (LPC) bus. Various devices may be coupled to second bus 620 including, for example, a keyboard and/or mouse 622, communication devices 627 and a storage unit 628 such as a disk drive or other mass storage device which may include instructions/code and data 630, in one embodiment. Further, an audio I/O 624 may be coupled to second bus 620. Note that other architectures are possible. For example, instead of the point-to-point architecture of FIG. 6, a system may implement a multi-drop bus or other such architecture.

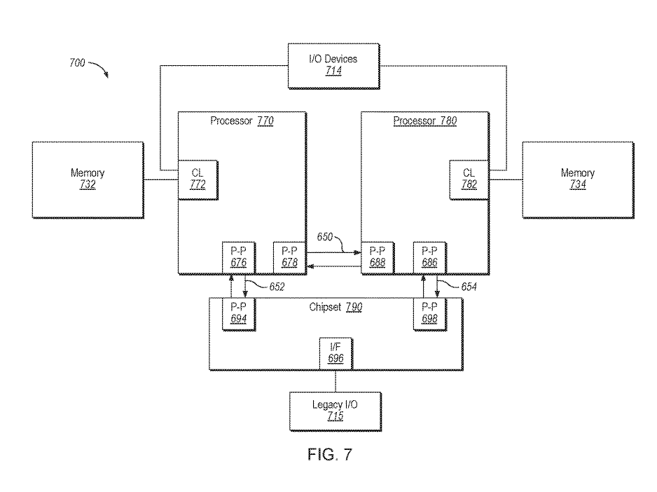

Referring now to FIG. 7, shown is a block diagram of a third system 700 in accordance with an embodiment of the present disclosure. Like elements in FIGS. 5 and 6 bear like reference numerals, and certain aspects of FIG. 6 have been omitted from FIG. 6 in order to avoid obscuring other aspects of FIG. 7.

FIG. 7 illustrates that the processors 770, 780 may include integrated memory and I/O control logic (“CL”) 772 and 782, respectively. For at least one embodiment, the CL 772, 782 may include integrated memory controller units such as described herein. In addition. CL 772, 782 may also include I/O control logic. FIG. 7 illustrates that the memories 732, 734 are coupled to the CL 772, 782, and that I/O devices 714 are also coupled to the control logic 772, 782. Legacy I/O devices 715 are coupled to the chipset 790. Aggregate Scatter operations discussed herein can be implemented in the processor 770, processor 780, or both.

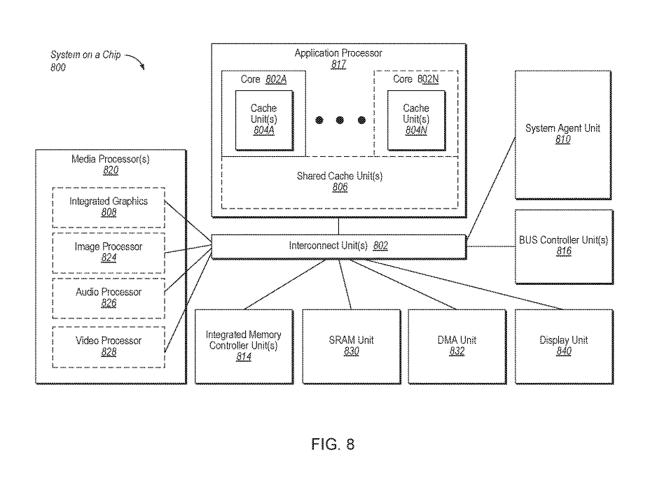

FIG. 8 is an exemplary system on a chip (SoC) 800 that may include one or more of the cores 802. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

FIG. 8 is a block diagram of a SoC 800 in accordance with an embodiment of the present disclosure. Dashed lined boxes are features on more advanced SoCs. In FIG. 8 an interconnect unit(s) 802 is coupled to: an application processor 817 which includes a set of one or more cores 802A-N, cache unit(s) 804A-N, and shared cache unit(s) 806; a system agent unit 810; a bus controller unit(s) 816; an integrated memory controller unit(s) 814; a set or one or more media processors 820 which may include integrated graphics logic 808, an image processor 824 for providing still and/or video camera functionality, an audio processor 826 for providing hardware audio acceleration, and a video processor 828 for providing video encode/decode acceleration; a static random access memory (SRAM) unit 830; a direct memory access (DMA) unit 832; and a display unit 840 for coupling to one or more external displays. Aggregate Scatter operations discussed herein can be implemented by SoC 800.

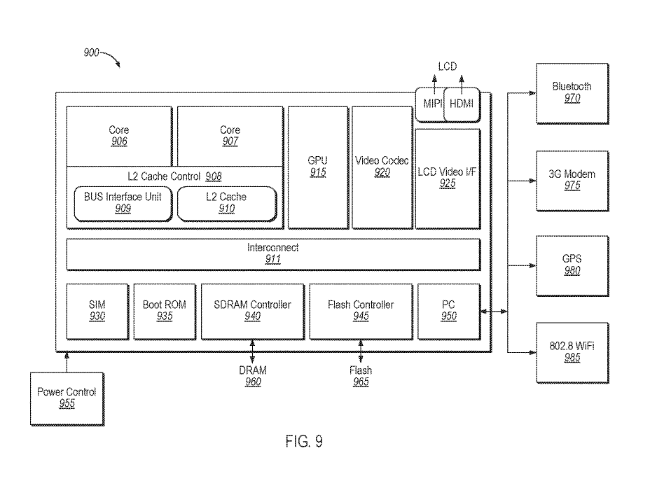

Turning next to FIG. 9, an embodiment of a system on-chip (SoC) design in accordance with embodiments of the disclosure is depicted. As an illustrative example, SoC 900 is included in user equipment (UE). In one embodiment, UE refers to any device to be used by an end-user to communicate, such as a hand-held phone, smartphone, tablet, ultra-thin notebook, notebook with broadband adapter, or any other similar communication device. A UE may connect to a base station or node, which can correspond in nature to a mobile station (MS) in a GSM network. Aggregate Scatter operations discussed herein can be implemented by SoC 900.

Here, SoC 900 includes 2 —cores-906 and 907. Similar to the discussion above, cores 906 and 907 may conform to an Instruction Set Architecture, such as a processor having the Intel® Architecture Core™, an Advanced Micro Devices, Inc. (AMD) processor, a MIPS-based processor, an ARM-based processor design, or a customer thereof, as well as their licensees or adopters. Cores 906 and 907 are coupled to cache control 908 that is associated with bus interface unit 909 and L2 cache 910 to communicate with other parts of system 900. Interconnect 911 includes an on-chip interconnect, such as an IOSF, AMBA, or other interconnects discussed above, which can implement one or more aspects of the described disclosure.

Interconnect 911 provides communication channels to the other components, such as a Subscriber Identity Module (SIM) 930 to interface with a SIM card, a boot ROM 935 to hold boot code for execution by cores 906 and 907 to initialize and boot SoC 900, a SDRAM controller 940 to interface with external memory (e.g. DRAM 960), a flash controller 945 to interface with non-volatile memory (e.g. Flash 965), a peripheral control 950 (e.g. Serial Peripheral Interface) to interface with peripherals, power control 955 to control power, video codecs 920 and Video interface 925 to display and receive input (e.g. touch enabled input), GPU 915 to perform graphics related computations, etc. Any of these interfaces may incorporate aspects of the embodiments described herein.

In addition, the system illustrates peripherals for communication, such as a Bluetooth module 970, 3G modem 975, GPS 980, and Wi-Fi 985. Note as stated above, a UE includes a radio for communication. As a result, these peripheral communication modules may not all be included. However, in a UE some form of a radio for external communication should be included.

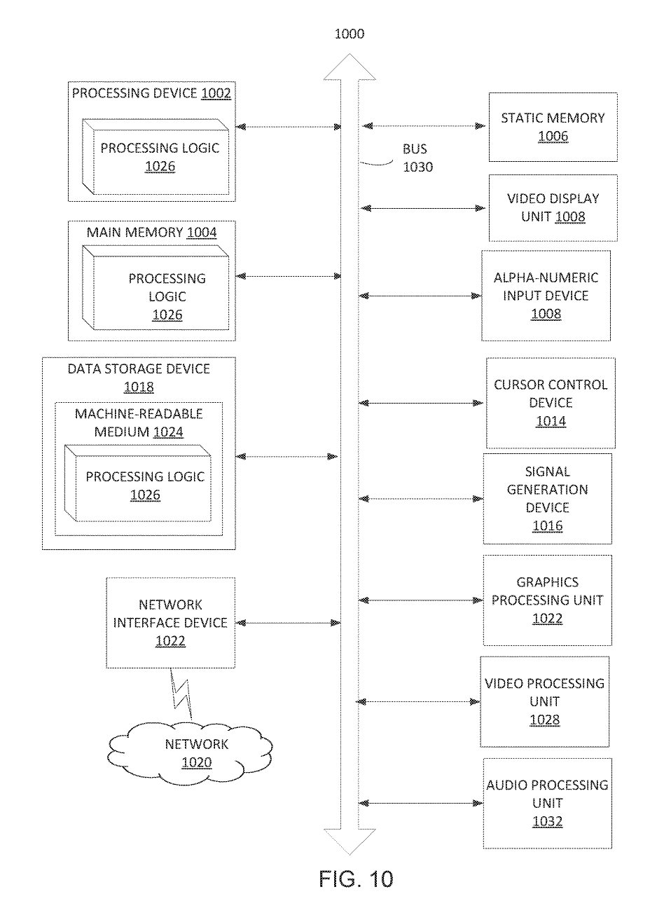

FIG. 10 illustrates a diagrammatic representation of a machine in the example form of a computing system 1000 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. The embodiments of the page additions and content copying can be implemented in computing system 1000.

The computing system 1000 includes a processing device 1002, main memory 904 (e.g., read-only memory (ROM), flash memory, dynamic random access memory (DRAM) (such as synchronous DRAM (SDRAM) or DRAM (RDRAM), etc.), a static memory 1026 (e.g., flash memory, static random access memory (SRAM), etc.), and a data storage device 1018, which communicate with each other via a bus 1030.

Processing device 1002 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. In one embodiment, processing device 1002 may include one or processor cores. The processing device 1002 is configured to execute the processing logic 1026 for performing the Aggregate Scatter operations discussed herein. In one embodiment, processing device 1002 can be part of a computing system. Alternatively, the computing system 1000 can include other components as described herein. It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

The computing system 1000 may further include a network interface device 1022 communicably coupled to a network 1020. The computing system 1000 also may include a video display unit 1008 (e.g., a liquid crystal display (LCD) or a cathode ray tube (CRT)), an alphanumeric input device 1010 (e.g., a keyboard), a cursor control device 1014 (e.g., a mouse), a signal generation device 1016 (e.g., a speaker), or other peripheral devices. Furthermore, computing system 1000 may include a graphics processing unit 1022, a video processing unit 1028 and an audio processing unit 1032. In another embodiment, the computing system 1000 may include a chipset (not illustrated), which refers to a group of integrated circuits, or chips, that are designed to work with the processing device 1002 and controls communications between the processing device 1002 and external devices. For example, the chipset may be a set of chips on a motherboard that links the processing device 1002 to very high-speed devices, such as main memory 1004 and graphic controllers, as well as linking the processing device 1002 to lower-speed peripheral buses of peripherals, such as USB, PCI or ISA buses.

The data storage device 1018 may include a computer-readable storage medium 1024 on which is stored software 1026 embodying any one or more of the methodologies of functions described herein. The software 1026 may also reside, completely or at least partially, within the main memory 1004 as instructions 1026 and/or within the processing device 1002 as processing logic 1026 during execution thereof by the computing system 1000; the main memory 1004 and the processing device 1002 also constituting computer-readable storage media.

The computer-readable storage medium 1024 may also be used to store instructions 1026 utilizing the processing device 1002 and/or a software library containing methods that call the above applications. While the computer-readable storage medium 1024 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the present embodiments. The term “computer-readable storage medium” shall accordingly be taken to include, but not be limited to, solid-state memories, and optical and magnetic media.

The following examples pertain to further embodiments.

Example 1 is a processor comprising:a memory interface; a register to store a first data structure comprising a first plurality of data elements that are contiguously stored in a first location in a memory accessible via the memory interface; a decoder to decode an aggregate scatter instruction specifying a store operation for the first data structure; and an execution unit coupled to the decoder, the execution unit to: in response to the decoded aggregate scatter instruction, contiguously store the first plurality of data elements of the first data structure to a second storage location in the memory, the second storage location identified by a starting memory address of the second storage location.

In Example two, the subject matter of Example 1, wherein the aggregate scatter instruction specifies: a datatype of the first data structure comprising the first plurality of data elements to be stored; the starting memory address of the second storage location, to where the first plurality of data elements is to be stored; an operand that identifies the register in which the first data structure is stored; and a size of the first data structure comprising the first plurality of data elements to be stored.

In Example 3, the subject matter of Examples 1-2, wherein the datatype of the first data comprises one of: a byte, word, dword, or quadword.

In Example 4, the subject matter of Examples 1-3, wherein the store operation is further to store the first data structure to the second storage location in the memory a second data structure comprising a second plurality of data elements to a third storage location in the memory, and wherein the first and second data structures were previously stored in a single vector register.

In Example 5, the subject matter of Examples 1-4, wherein the store operation is further to determine an address of the second data structure by adding a size of a datatype of the first data structure to a base address of the register.

In Example 6, the subject matter of Examples 1-5, wherein an array of structures comprises the first and second data structures.

In Example 7, the subject matter of Examples 1-6, wherein the store operation is further to store a subset of the first data structure, associated with the size of the data structure, wherein the subset is less than the size of the datatype.

Example 8 is a method comprising: decoding, by a processor, an aggregate scatter instruction specifying a store operation for a first plurality of data elements of a first data structure, wherein the first data structure is stored in a register associated with the processor, and wherein the first data elements were previously contiguously stored in a first location in a memory accessible via a memory interface; and in response to the decoded aggregate scatter instruction, storing contiguously, by the processor, the first plurality of data elements of the first data structure to a second storage location in the memory, the second storage location identified by a starting memory address of the second storage location.

In Example 9, the subject matter of Example 8, wherein the aggregate scatter comprises: a datatype of the first data structure comprising the first plurality of data elements to be stored; the starting memory address of the second storage location, to where the first plurality of data elements is to be stored; an operand that identifies the register in which the first data structure is stored; and a size of the first data structure comprising the first plurality of data elements to be stored.

In Example 10, the subject matter of Examples 8-9, wherein the datatype of the first data comprises one of: a byte, word, dword, or quadword.

In Example 11, the subject matter of Examples 8-10, further comprising: storing the first data structure to the second storage location in the memory; and storing a second data structure to a third storage location in the memory, the second data structure comprising a second plurality of data elements, and wherein the first data structure and the second data structure were previously stored in the register, the register being a single vector register.

In Example 12, the subject matter of Examples 8-11, further comprising determining an address of the second data structure by adding a size of a datatype of the first data structure to a base address of the register.

In Example 13, the subject matter of Examples 8-12, wherein an array of structures comprises the first and second data structures.

In Example 14, the subject matter of Examples 8-13, further comprising storing a subset of the first data structure, associated with the size of the data structure, wherein the subset is less than the size of the datatype.

Example 15 is a system on a chip (SoC) comprising: a memory; and a processor comprising a plurality of processor cores and coupled to the memory, wherein at least one of the plurality of processor cores is to: store, in a register associated with the processor, a first data structure comprising a first plurality of data elements that are contiguously stored in a first location in the memory accessible via a memory interface; decode an aggregate scatter instruction specifying a store operation for the first plurality of data elements of the first data structure; and in response to the decoded aggregate scatter instruction, store contiguously, the first plurality of data elements of the first data structure to a second storage location in the memory, the second storage location identified by a starting memory address of the second storage location.

In Example 16, the subject matter of Example 15, wherein the register is a vector register.

In Example 17, the subject matter of Examples 15-16, wherein the aggregate scatter instruction comprises: a datatype of the first data structure comprising the first plurality of data elements to be stored; the starting memory address of the second storage location, to where the first plurality of data elements is to be stored; an operand that identifies the vector register in which the first data structure is stored; and a size of the first data structure comprising the first plurality of data elements to be stored.

In Example 18, the subject matter of Examples 15-17, wherein the processor is further to: store the first data structure to the second storage location in the memory; and store a second data structure to a third storage location in the memory, the second data structure comprising a second plurality of data elements, and wherein the first data structure and the second data structure were previously stored in the register, the register being a single vector register.

In Example 19, the subject matter of Examples 15-18, wherein to store the second plurality of data elements the processor is further to determine an address of the second data structure by adding a size of a datatype of the first data structure to a base address of the register.

In Example 20, the subject matter of Examples 15-19, wherein an array of structures comprises the first and second data structures.

Example 21 is an apparatus comprising: means for decoding, by a processor, an aggregate scatter instruction specifying a store operation for a first plurality of data elements of a first data structure, wherein the first data structure is stored in a register associated with the processor, and wherein the first data elements were previously contiguously stored in a first location in a memory accessible via a memory interface; and means for, in response to the decoded aggregate scatter instruction, storing contiguously, by the processor, the first plurality of data elements of the first data structure to a second storage location in the memory, the second storage location identified by a starting memory address of the second storage location.

In Example 22, the subject matter of Example 21, further comprising: means for storing the first data structure to the second storage location in the memory; and means for storing a second data structure to a third storage location in the memory, the second data structure comprising a second plurality of data elements, and wherein the first data structure and the second data structure were previously stored in the register, the register being a single vector register.

In Example 23, the subject matter of Examples 21-22, further comprising a means for determining an address of the second data structure by adding a size of a datatype of the first data structure to a base address of the register.

In Example 24, the subject matter of Examples 21-23, means for performing the method of any one of claims 8-14.

In Example 25, the subject matter of Examples 21-24, a processor configured to perform the method of any one of claims 8-14.

Example 26 is a method comprising: decoding, by a processor, an aggregate scatter instruction specifying a store operation for a first plurality of data elements of a first data structure, wherein the first data structure is stored in a register associated with the processor, and wherein the first data elements were previously contiguously stored in a first location in a memory accessible via a memory interface; and in response to the decoded aggregate scatter instruction, storing contiguously, by the processor, the first plurality of data elements of the first data structure to a second storage location in the memory, the second storage location identified by a starting memory address of the second storage location.

In Example 27, the subject matter of Example 26, wherein the aggregate scatter comprises: a datatype of the first data structure comprising the first plurality of data elements to be stored; the starting memory address of the second storage location, to where the first plurality of data elements is to be stored; an operand that identifies the register in which the first data structure is stored; and a size of the first data structure comprising the first plurality of data elements to be stored.

In Example 28, the subject matter of Examples 26-27, further comprising: storing the first data structure to the second storage location in the memory; and storing a second data structure to a third storage location in the memory, the second data structure comprising a second plurality of data elements, and wherein the first data structure and the second data structure were previously stored in the register, the register being a single vector register.

In Example 29, the subject matter of Examples 26-28, further comprising determining an address of the second data structure by adding a size of a datatype of the first data structure to a base address of the register.

In Example 30, the subject matter of Examples 26-29, wherein an array of structures comprises the first and second data structures.

In Example 31, the subject matter of Examples 26-30, further comprising storing a subset of the first data structure, associated with the size of the data structure, wherein the subset is less than the size of the datatype.

Example 32 is a machine readable medium including code, when executed, to cause a machine to perform the method of any one of claims 26 to 31.

Example 33 is an apparatus comprising means for performing the method of any one of claims 26 to 31.

Example 34 is an apparatus comprising a processor configured to perform the method of any one of claims 26 to 31.

While embodiments of the present disclosure have been described with respect to a limited number of embodiments, those skilled in the art will appreciate numerous modifications and variations therefrom. It is intended that the appended claims cover all such modifications and variations as fall within the true spirit and scope of this present disclosure.

In the description herein, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of embodiments of the present disclosure. It will be apparent, however, to one skilled in the art that these specific details need not be employed to practice embodiments of the present disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system have not been described in detail in order to avoid unnecessarily obscuring embodiments of the present disclosure.

The embodiments are described with reference to Aggregate Scatter operations in specific integrated circuits, such as in computing platforms or microprocessors. The embodiments may also be applicable to other types of integrated circuits and programmable logic devices. For example, the disclosed embodiments are not limited to desktop computer systems or portable computers, such as the Intel® Ultrabooks™ computers. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. It is described that the system can be any kind of computer or embedded system. The disclosed embodiments may especially be used for low-end devices, like wearable devices (e.g., watches), electronic implants, sensory and control infrastructure devices, controllers, supervisory control and data acquisition (SCADA) systems, or the like. Moreover, the apparatuses, methods, and systems described herein are not limited to physical computing devices, but may also relate to software optimizations for energy conservation and efficiency. As will become readily apparent in the description below, the embodiments of methods, apparatuses, and systems described herein (whether in reference to hardware, firmware, software, or a combination thereof) are vital to a ‘green technology’ future balanced with performance considerations.

Although the embodiments herein are described with reference to a processor, other embodiments are applicable to other types of integrated circuits and logic devices. Similar techniques and teachings of embodiments of the present disclosure can be applied to other types of circuits or semiconductor devices that can benefit from higher pipeline throughput and improved performance. The teachings of embodiments of the present disclosure are applicable to any processor or machine that performs data manipulations. However, embodiments of the present disclosure are not limited to processors or machines that perform 512 bit, 256 bit, 128 bit, 64 bit, 32 bit, or 16 bit data operations and can be applied to any processor and machine in which manipulation or management of data is performed. In addition, the description herein provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

Although the below examples describe instruction handling and distribution in the context of execution units and logic circuits, other embodiments of the present disclosure can be accomplished by way of a data or instructions stored on a machine-readable, tangible medium, which when performed by a machine cause the machine to perform functions consistent with at least one embodiment of the disclosure. In one embodiment, functions associated with embodiments of the present disclosure are embodied in machine-executable instructions. The instructions can be used to cause a general-purpose or special-purpose processor that is programmed with the instructions to perform the steps of the present disclosure. Embodiments of the present disclosure may be provided as a computer program product or software which may include a machine or computer-readable medium having stored thereon instructions which may be used to program a computer (or other electronic devices) to perform one or more operations according to embodiments of the present disclosure. Alternatively, operations of embodiments of the present disclosure might be performed by specific hardware components that contain fixed-function logic for performing the operations, or by any combination of programmed computer components and fixed-function hardware components.

Instructions used to program logic to perform embodiments of the disclosure can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “storing,” “decoding,” “identifying,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

What is claimed is:

1. A processor comprising:
a memory interface;
a register to store a first data structure comprising a first plurality of data elements that are contiguously stored in a first location in a memory accessible via the memory interface;
a decoder to decode an aggregate scatter instruction specifying a store operation for the first data structure; and
an execution unit coupled to the decoder, the execution unit to:
in response to the decoded aggregate scatter instruction, contiguously store the first plurality of data elements of the first data structure to a second storage location in the memory, the second storage location identified by a starting memory address of the second storage location.

2. The processor of claim 1, wherein the aggregate scatter instruction specifies:
a datatype of the first data structure comprising the first plurality of data elements to be stored;
the starting memory address of the second storage location, to where the first plurality of data elements is to be stored;
an operand that identifies the register in which the first data structure is stored; and
a size of the first data structure comprising the first plurality of data elements to be stored.

3. The processor of claim 2, wherein the datatype of the first data comprises one of: a byte, word, dword, or quadword.

4. The processor of claim 1, wherein the store operation is further to store the first data structure to the second storage location in the memory a second data structure comprising a second plurality of data elements to a third storage location in the memory, and wherein the first and second data structures were previously stored in a single vector register.

5. The processor of claim 4, wherein the store operation is further to determine an address of the second data structure by adding a size of a datatype of the first data structure to a base address of the register.

6. The processor of claim 4, wherein an array of structures comprises the first and second data structures.

7. The processor of claim 2, wherein the store operation is further to store a subset of the first data structure, associated with the size of the data structure, wherein the subset is less than the size of the datatype.

8. A method comprising:
decoding, by a processor, an aggregate scatter instruction specifying a store operation for a first plurality of data elements of a first data structure, wherein the first data structure is stored in a register associated with the processor, and wherein the first data elements were previously contiguously stored in a first location in a memory accessible via a memory interface; and
in response to the decoded aggregate scatter instruction, storing contiguously, by the processor, the first plurality of data elements of the first data structure to a second storage location in the memory, the second storage location identified by a starting memory address of the second storage location.

9. The method of claim 8, wherein the aggregate scatter comprises:
a datatype of the first data structure comprising the first plurality of data elements to be stored;
the starting memory address of the second storage location, to where the first plurality of data elements is to be stored;
an operand that identifies the register in which the first data structure is stored; and
a size of the first data structure comprising the first plurality of data elements to be stored.

10. The method of claim 9, wherein the datatype of the first data comprises one of: a byte, word, dword, or quadword.

11. The method of claim 8, further comprising:
storing the first data structure to the second storage location in the memory; and
storing a second data structure to a third storage location in the memory, the second data structure comprising a second plurality of data elements, and wherein the first data structure and the second data structure were previously stored in the register, the register being a single vector register.

12. The method of claim 11, further comprising determining an address of the second data structure by adding a size of a datatype of the first data structure to a base address of the register.

13. The method of claim 11, wherein an array of structures comprises the first and second data structures.

14. The method of claim 9, further comprising storing a subset of the first data structure, associated with the size of the data structure, wherein the subset is less than the size of the datatype.

15. A system on a chip (SoC) comprising:
a memory; and
a processor comprising a plurality of processor cores and coupled to the memory, wherein at least one of the plurality of processor cores is to:
store, in a register associated with the processor, a first data structure comprising a first plurality of data elements that are contiguously stored in a first location in the memory accessible via a memory interface;
decode an aggregate scatter instruction specifying a store operation for the first plurality of data elements of the first data structure; and
in response to the decoded aggregate scatter instruction, store contiguously, the first plurality of data elements of the first data structure to a second storage location in the memory, the second storage location identified by a starting memory address of the second storage location.

16. The SoC of claim 15, wherein the register is a vector register.

17. The SoC of claim 16, wherein the aggregate scatter instruction comprises:
a datatype of the first data structure comprising the first plurality of data elements to be stored;
the starting memory address of the second storage location, to where the first plurality of data elements is to be stored;
an operand that identifies the vector register in which the first data structure is stored; and
a size of the first data structure comprising the first plurality of data elements to be stored.

18. The SoC of claim 15, wherein the processor is further to:
store the first data structure to the second storage location in the memory; and
store a second data structure to a third storage location in the memory, the second data structure comprising a second plurality of data elements, and wherein the first data structure and the second data structure were previously stored in the register, the register being a single vector register.

19. The SoC of claim 18, wherein to store the second plurality of data elements the processor is further to determine an address of the second data structure by adding a size of a datatype of the first data structure to a base address of the register.

20. The SoC of claim 18, wherein an array of structures comprises the first and second data structures.
